(19) United States
(12) Patent Application Publication
(10) Pub. No.: US 2026/0117572 A1
(43) Pub. Date: Apr. 30, 2026

(54) ADJUSTABLE DOOR HINGE STRUCTURE

(71) Applicants: Hyundai Motor Company, Seoul (KR); Kia Corporation, Seoul (KR)

(72) Inventors: Zuobin LI, Yantai (CN); Hai Liang Wang, Yantai (CN)

(73) Assignees: Hyundai Motor Company, Seoul (KR); Kia Corporation, Seoul (KR)

(21) Appl. No.: 18/965,659

(22) Filed: Dec. 2, 2024

(30) Foreign Application Priority Data
Oct. 24, 2024 (CN) 202411489682.7

(51) Int. Cl. E05D 7/04

(52) U.S. Cl. CPC E05D 7/0415; E05D 2007/0461; E05Y 2900/531

(57) ABSTRACT

An adjustable door hinge structure includes: a mounting bracket mounted on a vehicle body; a hinge arm including a first end portion fixed to a door and a second end portion rotatably connected to the mounting bracket; and a position-limiting assembly including a housing fixed to the mounting bracket and a shaft protruding from an inside of the housing, wherein the shaft is configured for being moved relative to the housing to change a length by which a first end portion of the shaft protrudes from an inside of the housing, thus changing the maximum rotation angle of the hinge arm relative to the mounting bracket. The adjustable door hinge structure may improve a passenger's boarding experience by adjusting the maximum door opening angle to make it convenient for the passenger to get on and/or off a vehicle or close a door after boarding the vehicle.

### CROSS-REFERENCE TO RELATED APPLICATION

The present application claims priority to Chinese Patent Application No. 202411489682.7 filed in the Chinese National Intellectual Property Administration on Oct. 24, 2024, the entire contents of which is incorporated herein for all purposes by this reference.

### BACKGROUND OF THE PRESENT DISCLOSURE

### Field of the Present Disclosure

The present disclosure relates to a vehicle field, and more particularly, to an adjustable door hinge structure.

### Description of Related Art

In general, a door may be connected to a vehicle body through a hinge structure, and may limit the maximum angle at which the door is capable of being opened (hereinafter referred to as the “maximum door opening angle”) through a position-limiting device disposed on the hinge structure. However, in a conventional door hinge structure, the maximum door opening angle is usually unable to be adjusted once a vehicle setup is completed at a factory. Accordingly, the conventional door hinge structure may have a very significant limitation. Meanwhile, if the maximum door opening angle is small, it may be inconvenient for a larger passenger to get on or off a vehicle. On the other hand, if the maximum door opening angle is large, it may be inconvenient for a smaller passenger to extend his or her arm to close the door after getting on. The present inconvenience may result in a poor riding experience for the passenger.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an adjustable door hinge structure configured for improving a passenger's boarding experience by adjusting a maximum door opening angle to make it convenient for the passenger to get on and/or off a vehicle or close a door after boarding the vehicle.

According to a first aspect, provided is an adjustable door hinge structure.

The structure includes: a mounting bracket mounted on a vehicle body; a hinge arm including a first end portion fixed to a door and a second end portion rotatably connected to the mounting bracket; and a position-limiting assembly including a housing fixed to the mounting bracket and a shaft protruding from an inside of the housing, wherein the shaft is configured for being moved relative to the housing to change a length by which a first end portion of the shaft protrudes from an inside of the housing, thus changing a maximum rotation angle of the hinge arm relative to the mounting bracket.

The position-limiting assembly may further include: a position-limiting pin provided in the housing, a position-limiting groove corresponding to the position-limiting pin provided at a middle portion of the shaft, and an elastic member including a first end portion in contact with an end portion of the housing and a second end portion in contact with the shaft, and the elastic member may allow the position-limiting pin to be slid to a predetermined position within the position-limiting groove to change the length by which the first end portion of the shaft protrudes from the inside of the housing.

A stop ring may be disposed between the first end portion and the position-limiting groove, the stop ring may extend radially outwardly from a surface of the shaft, and the elastic member may include the other end portion in contact with the stop ring of the shaft.

The position-limiting groove may include a first slide section, a second slide section, a third slide section, a fourth slide section, a fifth slide section, a sixth slide section, a seventh slide section, an eighth slide section, a ninth slide section, a tenth slide section, an eleventh slide section, and a twelfth slide section, a loop may be formed by sequentially connecting the first slide section, the second slide section, the third slide section, the fourth slide section, the fifth slide section, the sixth slide section, the seventh slide section, the eighth slide section, the ninth slide section, the tenth slide section, the eleventh slide section, and the twelfth slide section to each other, and a first position-limiting portion may be disposed at a connection end portion between the twelfth slide section and the first slide section, a second position-limiting portion may be disposed at a connection end portion between the third slide section and the fourth slide section, a third position-limiting portion may be disposed at a connection end portion between the sixth slide section and the seventh slide section, and a fourth position-limiting portion may be disposed at a connection end portion between the ninth slide section and the tenth slide section.

The first end portion of the shaft may protrude from the inside of the housing by a first predetermined length when the position-limiting pin is slid from the first position-limiting portion to the second position-limiting portion sequentially along the first slide section, the second slide section, and the third slide section, while the shaft is simultaneously rotated, the first end portion of the shaft may protrude from the inside of the housing by a second predetermined length when the position-limiting pin is slid from the second position-limiting portion to the third position-limiting portion sequentially along the fourth slide section, the fifth slide section, and the sixth slide section, while the shaft is simultaneously rotated, the first end portion of the shaft may protrude from the inside of the housing by a third predetermined length when the position-limiting pin is slid from the third position-limiting portion to the fourth position-limiting portion sequentially along the seventh slide section, the eighth slide section, and the ninth slide section, while the shaft is simultaneously rotated, and the first end portion of the shaft may protrude from the inside of the housing by a fourth predetermined length when the position-limiting pin is slid from the fourth position-limiting portion to the first position-limiting portion sequentially along the tenth slide section, the eleventh slide section, and the twelfth slide section, while the shaft is simultaneously rotated.

The position-limiting groove may be provided with a first transfer portion disposed at a connection end portion between the first slide section and the second slide section, a second transfer portion disposed at a connection end portion between the fourth slide section and the fifth slide section, a third transfer portion disposed at a connection end portion between the seventh slide section and the eighth slide section, and a fourth transfer portion disposed at a connection end portion between the tenth slide section and the eleventh slide section.

The mounting bracket may include a base plate fixedly mounted on the vehicle body, two mounting plates each facing the base plate and including an axial hole, and a connection plate connecting the two mounting plates to each other and including a connection hole.

The hinge arm may include a main body formed as an arc-shaped plate, a fixing plate disposed at one end portion of the main body and fixed to an internal plate of the door, and a rotation shaft provided at the other end portion of the main body and passing through the axial hole.

A hook connection may be disposed on the housing, and the housing may be hooked to the connection plate by the hook connection.

According to a second aspect, provided is a vehicle including the adjustable door hinge structure according to the first aspect.

The present disclosure may provide the adjustable door hinge structure configured for improving the passenger's boarding experience by adjusting the maximum door opening angle based on the different needs of the passengers to make it convenient for the passenger to get on and/or off the vehicle or close the door after boarding the vehicle.

The device included in an exemplary embodiment of the present disclosure has other features and advantages, which are either apparent from or described in detail in the accompanying drawings and embodiments described below, all of which are intended to illustrate the predetermined principles of the present disclosure.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic view showing an entire structure of an adjustable door hinge structure according to an exemplary embodiment of the present disclosure.

FIG. 2 is a schematic view showing that a hinge arm of an adjustable door hinge structure is mounted on a mounting bracket according to an exemplary embodiment of the present disclosure.

FIG. 3 is a schematic view showing that a position-limiting assembly of an adjustable door hinge structure is mounted on a mounting bracket according to an exemplary embodiment of the present disclosure.

FIG. 4 is a schematic view of a position-limiting assembly of an adjustable door hinge structure according to an exemplary embodiment of the present disclosure.

FIG. 5 is an exploded view of a position-limiting assembly of an adjustable door hinge structure according to an exemplary embodiment of the present disclosure.

FIG. 6 is a schematic view of a housing of an adjustable door hinge structure according to an exemplary embodiment of the present disclosure.

FIG. 7 is a cross-sectional view taken along a line A-A in FIG. 4.

FIG. 8 is a schematic view showing an adjustable door hinge structure when a door is closed according to an exemplary embodiment of the present disclosure.

FIG. 9 is a schematic view showing an adjustable door hinge structure when a door is opened to a maximum angle according to an exemplary embodiment of the present disclosure.

FIG. 10 is a cross-sectional view taken along a line B-B in FIG. 8.

FIG. 11 is a cross-sectional view taken along a line C-C in FIG. 9.

FIG. 12 is a schematic view showing that a position-limiting groove of an adjustable door hinge structure extends along an external circumference of a shaft according to an exemplary embodiment of the present disclosure.

FIG. 13 is a schematic view showing that a position-limiting pin of an adjustable door hinge structure is slid relatively to a predetermined position within a position-limiting groove according to an exemplary embodiment of the present disclosure.

FIG. 14A, FIG. 14B, FIG. 14C, FIG. 14D, FIG. 14E, and FIG. 14F are schematic views showing a process in which a position-limiting pin of an adjustable door hinge structure is slid relatively from a first position-limiting portion to a second position-limiting portion within a position-limiting groove according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

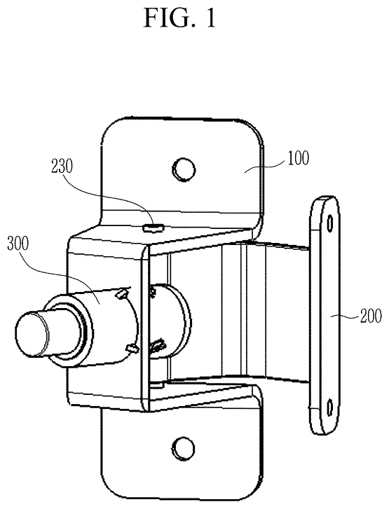

Hereinafter, an adjustable door hinge structure according to an exemplary embodiment of the present disclosure is described with reference to FIGS. 1 to 14F.

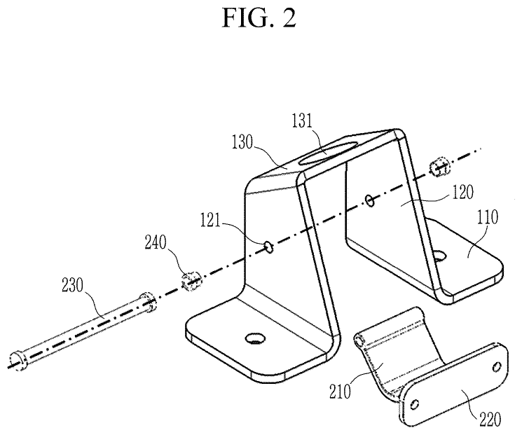

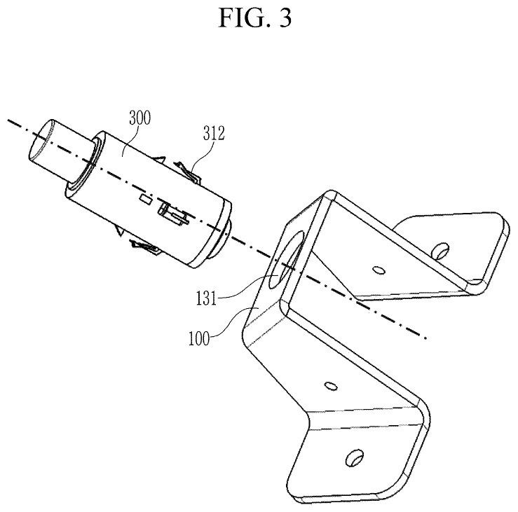

FIG. 1 is a schematic view showing an entire structure of an adjustable door hinge structure according to an exemplary embodiment of the present disclosure. FIG. 2 is a schematic view showing that a hinge arm of an adjustable door hinge structure is mounted on a mounting bracket according to an exemplary embodiment of the present disclosure. FIG. 3 is a schematic view showing that a position-limiting assembly of an adjustable door hinge structure is mounted on a mounting bracket according to an exemplary embodiment of the present disclosure.

As shown in FIG. 1, the adjustable door hinge structure according to an exemplary embodiment of the present disclosure may include a mounting bracket 100, a hinge arm 200, and a position-limiting assembly 300.

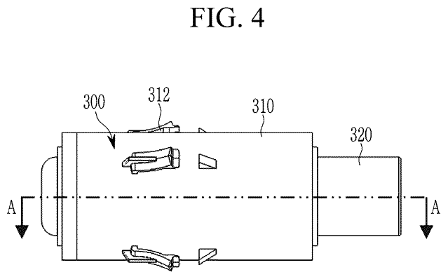

The mounting bracket 100 may be mounted on a vehicle body. The hinge arm 200 may have one end portion fixed to an internal plate of a door, and the other end portion rotatably connected to the mounting bracket 100. Referring to FIG. 3 and FIG. 4, the position-limiting assembly 300 may include a housing 310 fixed to the mounting bracket 100 and a shaft 320 protruding from an inside of the housing 310. Here, the shaft 320 may be moved relative to the housing 310 to change a length by which a first end portion 321 of the shaft 320 protrudes from the inside of the housing 310, thus changing the maximum rotation angle of the hinge arm 200 relative to the mounting bracket 100.

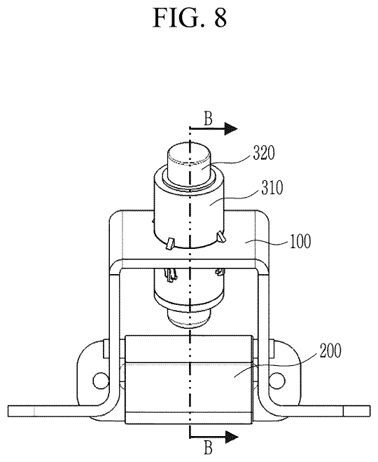

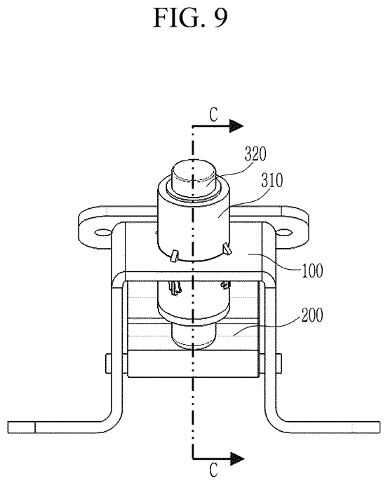

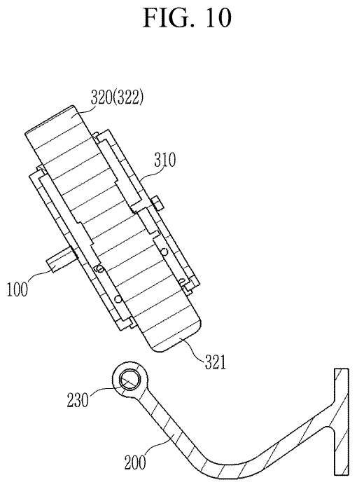

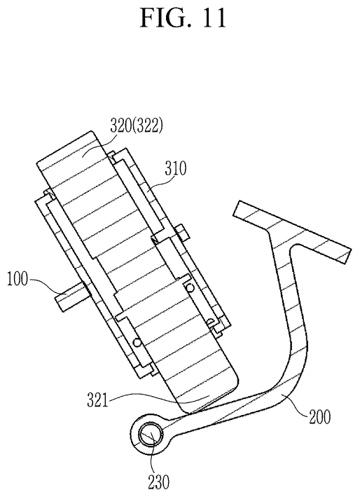

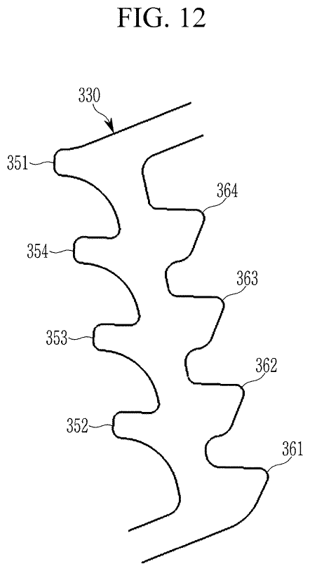

In detail, referring to FIG. 8, FIG. 9, FIG. 10 and FIG. 11, when the door is closed, the hinge arm 200 may not be in contact with the first end portion 321 of the shaft 320. When the door is opened to the maximum angle, the hinge arm 200 may be in contact with the first end portion 321 of the shaft 320, thus preventing the hinge arm 200 from being rotated relative to the mounting bracket 100 in a direction in which the door is opened. In the present process, the movement of the shaft 320 relative to the housing 310 may be adjusted, changing the length by which the first end portion 321 of the shaft 320 protrudes from the inside of the housing 310. Accordingly, when the door is opened, the hinge arm 200 may come into contact with the first end portion 321 of the shaft 320 earlier or later. In the present way, the maximum rotation angle of the hinge arm 200 relative to the mounting bracket 100 may be adjusted, thus adjusting the maximum door opening angle to make it convenient for a passenger to get on and/or off a vehicle or close the door after boarding the vehicle. Therefore, the passenger's boarding experience may be improved.

In detail, referring to FIG. 2, the mounting bracket 100 may include a base plate 110, two mounting plates 120, and a connection plate 130. Two mounting holes may be formed in the base plate 110, and a fastening member such as a bolt may pass through each of the two mounting holes to fixedly mount the base plate 110 to the vehicle body. The two mounting plates 120 may be disposed on the base plate 110 to face each other, and each include an axial hole 121 formed therein. The connection plate 130 may connect the two mounting plates 120 to each other.

Furthermore, referring to FIG. 3, a connection hole 131 may be formed in the connection plate 130. A hook connection 312 may be disposed on an external surface of the housing 310, and the housing 310 may pass through the connection hole 131 to be hooked to the connection plate 130 by the hook connection 312, thus fixing the housing 310 to the mounting bracket 100. In an exemplary embodiment of the present disclosure, the number of hook connections 312 may be set to 4 and the hook connections 312 may be evenly distributed on the external surface of the housing 310. However, it is to be noted that the number and positions of the hook connections 312 may be adjusted appropriately as needed.

Furthermore, referring to FIG. 1 and FIG. 2, the hinge arm 200 may include a main body 210, a fixing plate 220, and a rotation shaft 230. The main body 210 may be provided as an arc-shaped plate. The fixing plate 220 may be disposed at one end portion of the main body 210. The fixing plate 220 may be fixed to the internal plate of the door by the fastening member. The rotation shaft 230 may be provided at the other end portion of the main body 210 and pass through the axial hole 121. Two first bushings 240 may each be provided at two end portions of the rotation shaft 230 corresponding to the axial hole 121, and the rotation shaft 230 may be rotated relative to the two first bushings 240, thus rotatably mounting the hinge arm 200 on the mounting bracket 100.

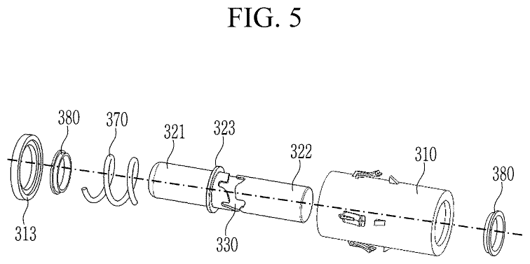

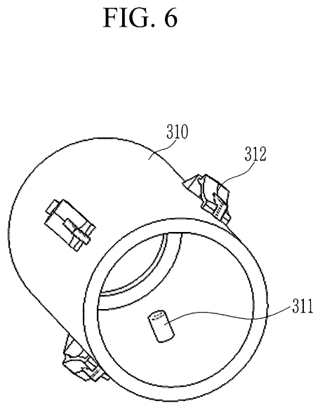

According to an exemplary embodiment of the present disclosure, as shown in FIG. 6, a position-limiting pin 311 may be disposed at the housing 310, and the position-limiting pin 311 may extend radially inwardly from an internal surface of the housing 310. As shown in FIG. 5, a position-limiting groove 330 corresponding to the position-limiting pin 311 may be formed in a middle portion of the shaft 320. The position-limiting assembly 300 may further include an elastic member 370 including one end portion in contact with an end portion of the housing 310 and the other end portion in contact with the shaft 320. The elastic member 370 may allow the position-limiting pin 311 to be relatively slid to a predetermined position within the position-limiting groove to change the length by which the first end portion of the shaft 320 protrudes from the inside of the housing 310.

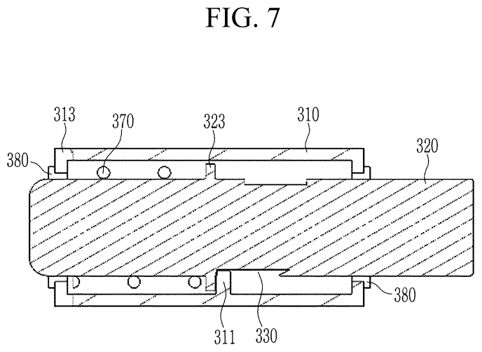

In detail, as shown in FIG. 5, the shaft 320 may include a second end portion 322 and a stop ring 323 disposed between the first end portion 321 and the position-limiting groove 330. The stop ring 323 may extend radially outwardly from a surface of the shaft 320. A cap 313 may be mounted at the end portion of the housing 310, and the cap 313 may be fixedly connected to the housing 310 by a connection method such as welding. An elastic force of the elastic member 370 may be preset, one end portion of the elastic member 370 may be in contact with an edge portion of the cap 313 of the housing 310, and the other end portion of the elastic member 370 may be in contact with the stop ring 323 of the shaft 320. The elastic member 370 may be easily mounted due to the cap 313, which is advantageous in cost saving. Furthermore, in an exemplary embodiment of the present disclosure, as shown in FIG. 5 and FIG. 7, a second bushing 380 may be mounted on each of two end portions of the housing 310, and the second bushing 380 may be disposed between the housing 310 and the shaft 320 to reduce friction with the housing 310 when the shaft 320 is moved relative to the housing 310. Furthermore, in an exemplary embodiment of the present disclosure, the elastic member 370 may be provided as a spring, and it is to be noted that the elastic member 370 is not limited to the present type, and may have any form in the related art as long as the elastic member 370 may realize the above function.

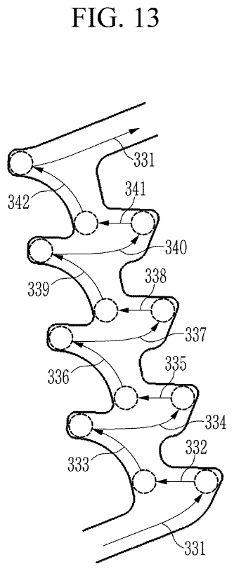

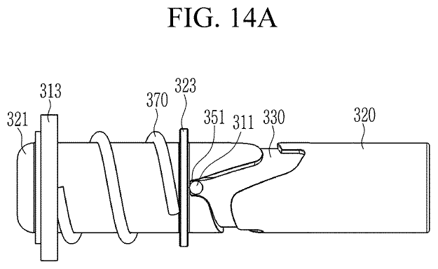

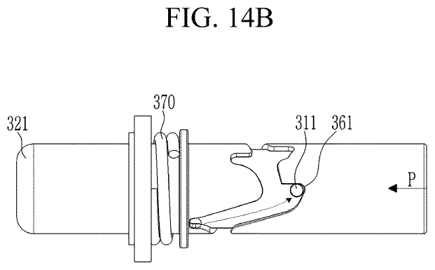

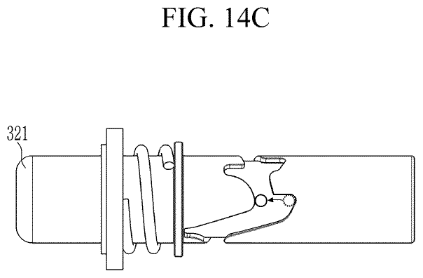

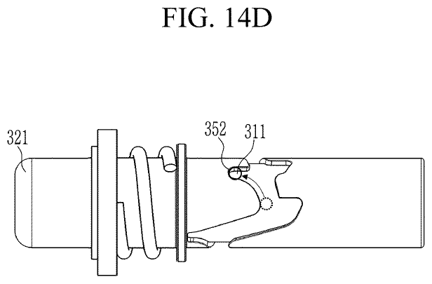

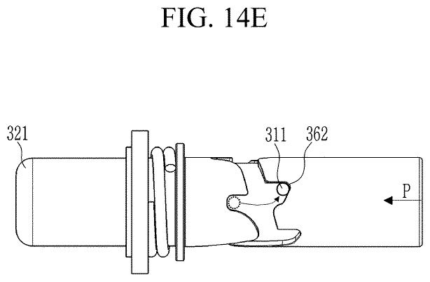

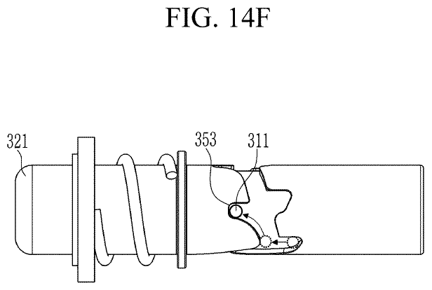

FIG. 12 is a schematic view showing that a position-limiting groove of an adjustable door hinge structure extends along an external circumference of a shaft according to an exemplary embodiment of the present disclosure. FIG. 13 is a schematic view showing that a position-limiting pin of an adjustable door hinge structure is slid relatively to a predetermined position within a position-limiting groove according to an exemplary embodiment of the present disclosure. FIG. 14A, FIG. 14B, FIG. 14C, FIG. 14D, FIG. 14E, and FIG. 14F are schematic views showing processes in which a position-limiting pin of an adjustable door hinge structure is slid relatively from a first position-limiting portion to a second position-limiting portion within a position-limiting groove according to an exemplary embodiment of the present disclosure.

According to an exemplary embodiment of the present disclosure, as shown in FIG. 12, and FIG. 13, the position-limiting groove 330 may include a first slide section 331, a second slide section 332, a third slide section 333, a fourth slide section 334, a fifth slide section 335, a sixth slide section 336, a seventh slide section 337, an eighth slide section 338, a ninth slide section 339, a tenth slide section 340, an eleventh slide section 341, and a twelfth slide section 342. A loop may be formed by sequentially connecting the first slide section 331, the second slide section 332, the third slide section 333, the fourth slide section 334, the fifth slide section 335, the sixth slide section 336, the seventh slide section 337, the eighth slide section 338, the ninth slide section 339, the tenth slide section 340, the eleventh slide section 341, and the twelfth slide section 342 to each other. Furthermore, a first position-limiting portion 351 may be disposed at a connection end portion between the twelfth slide section 342 and the first slide section 331. A second position-limiting portion 352 may be disposed at a connection end portion between the third slide section 333 and the fourth slide section 334. A third position-limiting portion 353 may be disposed at a connection end portion between the sixth slide section 336 and the seventh slide section 337. A fourth position-limiting portion 354 may be disposed at a connection end portion between the ninth slide section 339 and the tenth slide section 340.

As shown in FIG. 14A, if the position-limiting pin 311 is disposed in the first position-limiting portion 351, the present position may be considered as an initial position thereof. Here, the elastic member 370 may be in a stable state where the elastic member 370 has the longest length (the stable state where the elastic member 370 is not compressed or slightly compressed), the length by which the first end portion 321 of the shaft 320 protrudes from the inside of the housing 310 may be the shortest (an initial length), the maximum rotation angle of the hinge arm 200 relative to the mounting bracket 100 may be the largest, and the maximum angle at which the door is configured for being opened may be the largest.

The first end portion 321 of the shaft 320 may protrude from the inside of the housing 310 by a first predetermined length when the position-limiting pin 311 is relatively slid from the first position-limiting portion 351 to the second position-limiting portion 352 sequentially along the first slide section 331, the second slide section 332, and the third slide section 333, while the shaft 320 is simultaneously rotated. Here, the elastic member 370 may be compressed to a stable state where the elastic member 370 has the shortest length, the length by which the first end portion 321 of the shaft 320 protrudes from the inside of the housing 310 may be the longest, the maximum rotation angle of the hinge arm 200 relative to the mounting bracket 100 may be the smallest, and the maximum angle at which the door is configured for being opened may be the smallest (see FIGS. 14A to 14D).

The first end portion 321 of the shaft 320 may protrude from the inside of the housing 310 by a second predetermined length when the position-limiting pin 311 is relatively slid from the second position-limiting portion 352 to the third position-limiting portion 353 sequentially along the fourth slide section 334, the fifth slide section 335, and the sixth slide section 336, while the shaft 320 is simultaneously rotated. Here, a degree to which the elastic member 370 is compressed may be reduced (here, the length of the elastic member 370 may be longer than the shortest length of the elastic member 370 when the elastic member 370 is compressed to the stable state), the length by which the first end portion 321 of the shaft 320 protrudes from the inside of the housing 310 may be shorter, the maximum rotation angle of the hinge arm 200 relative to the mounting bracket 100 may be greater, and the maximum angle at which the door may be opened may be greater (see FIGS. 14E and 14F).

The first end portion 321 of the shaft 320 may protrude from the inside of the housing 310 by a third predetermined length when the position-limiting pin 311 is relatively slid from the third position-limiting portion 353 to the fourth position-limiting portion 354 sequentially along the seventh slide section 337, the eighth slide section 338, and the ninth slide section 339, while the shaft 320 is simultaneously rotated. Here, the degree to which the elastic member 370 is compressed may be further reduced, the length by which the first end portion 321 of the shaft 320 protrudes from the inside of the housing 310 may become even shorter, the maximum rotation angle of the hinge arm 200 relative to the mounting bracket 100 may be even greater, and the maximum angle at which the door is configured for being opened may be even greater.

The first end portion 321 of the shaft 320 may protrude from the inside of the housing 310 by a fourth predetermined length (the initial length) when the position-limiting pin 311 is relatively slid from the fourth position-limiting portion 354 to the first position-limiting portion 351 sequentially along the tenth slide section 340, the eleventh slide section 341, and the twelfth slide section 342, while the shaft 320 is simultaneously rotated. In the above process, the shaft 320 may be rotated by one turn, and the position-limiting pin 311 may thus be moved to the initial position within the position-limiting groove 330 of the shaft 320. Here, the elastic member 370 may be restored to the stable state where the elastic member 370 has the longest length, the length by which the first end portion 321 of the shaft 320 protrudes from the inside of the housing 310 may be the shortest (the initial length), the maximum rotation angle of the hinge arm 200 relative to the mounting bracket 100 may be the greatest, and the maximum angle at which the door is configured for being opened may be the greatest.

Furthermore, the position-limiting groove 330 may be provided with a first transfer portion 361 disposed at a connection end portion between the first slide section 331 and the second slide section 332, and the position-limiting pin 311 may thus be transferred from the first slide section 331 to the second slide section 332 through the first transfer portion 361 when the position-limiting pin 311 is slid to the connection end portion between the first slide section 331 and the second slide section 332. The position-limiting groove 330 may be provided with a second transfer portion 362 disposed at a connection end portion between the fourth slide section 334 and the fifth slide section 335, and the position-limiting pin 311 may thus be transferred from the fourth slide section 334 to the fifth slide section 335 through the second transfer portion 362 when the position-limiting pin 331 is slid to the connection end portion between the fourth slide section 334 and the fifth slide section 335. The position-limiting groove 330 may be provided with a third transfer portion 363 disposed at a connection end portion between the seventh slide section 337 and the eighth slide section 338, and the position-limiting pin 311 may thus be transferred from the seventh slide section 337 to the eighth slide section 338 through the third transfer portion 363 when the position-limiting pin 311 is slid to the connection end portion between the seventh slide section 337 and the eighth slide section 338. The position-limiting groove 330 may be provided with a fourth transfer portion 364 disposed at a connection end portion between the tenth slide section 340 and the eleventh slide section 341, and the position-limiting pin 311 may thus be transferred from the tenth slide section 340 to the eleventh slide section 341 through the fourth transfer portion 364 when the position-limiting pin 311 is slid to the connection end portion between the tenth slide section 340 and the eleventh slide section 341.

In an exemplary embodiment of the present disclosure, the first position-limiting portion 351, the second position-limiting portion 352, the third position-limiting portion 353, and the fourth position-limiting portion 354 may be provided to thus adjust the length by which the first end portion 321 of the shaft 320 protrudes from the inside of the housing 310 to corresponding to the initial length (or the fourth predetermined length), the first predetermined length, the second predetermined length, or the third predetermined length. It is to be described that more position-limiting portions may be selectively provided based on an actual need to thus adjust the length of the first end portion 321 protruding from the inside of the housing 310 to correspond to more predetermined lengths. Accordingly, the door may have more adjustable options for the maximum angle at which the door is configured for being opened.

An exemplary embodiment of the present disclosure may further provide the vehicle including the adjustable door hinge structure.

Hereinafter, an operation process of the adjustable door hinge structure according to an exemplary embodiment of the present disclosure may be described with reference to the drawings.

In a general situation, as shown in FIG. 14A, the position-limiting pin 311 of the adjustable door hinge structure according to an exemplary embodiment of the present disclosure may be disposed at the first position-limiting portion 351, which may be considered as the initial position thereof. Here, the elastic member 370 may be in the stable state where the elastic member 370 has the longest length (the stable state where the elastic member 370 is not compressed or slightly compressed), the length by which the first end portion 321 of the shaft 320 protrudes from the inside of the housing 310 may be the shortest (the initial length), the maximum rotation angle of the hinge arm 200 relative to the mounting bracket 100 may be the greatest, and the maximum angle at which the door is configured for being opened may be the greatest.

When the maximum door opening angle needs to be adjusted, as shown in FIGS. 14A to 14D, the passenger may apply a thrust P to the second end portion 322 of the shaft 320 for the shaft 320 to overcome the elastic force of the elastic member 370, allowing the position-limiting pin 311 to be slid relatively from the first position-limiting portion 351 to the first transfer portion 361 along the first slide section 331. The passenger may then stop applying the thrust P, thus allowing the shaft 320 to be transferred from the first transfer portion 361 to the second slide section 332 by action of the elastic restoring force of the elastic member 370, and allowing the shaft 320 to be slid to the second position-limiting portion 352 along the second slide section 332 and the third slide section 333. In the present process, the shaft 320 may be rotated. In the present way, the first end portion 321 of the shaft 320 may protrude from the inside of the housing 310 by the first predetermined length. Here, the elastic member 370 may be compressed to the stable state where the elastic member 370 has the shortest length, the length by which the first end portion 321 of the shaft 320 protrudes from the inside of the housing 310 may be the longest, the maximum rotation angle of the hinge arm 200 relative to the mounting bracket 100 may be the smallest, and the maximum angle at which the door is configured for being opened may be the smallest.

Furthermore, when the passenger continuously applies the thrust P to the second end portion 322 of the shaft 320, as shown in FIGS. 14E and 14F, the shaft 320 may overcome the elastic force of the elastic member 370, and the position-limiting pin 311 may be slid relatively from the second position-limiting portion 352 to the second transfer portion 362 along the fourth slide section 334. The passenger may then stop applying the thrust P, thus allowing the shaft 320 to be transferred from the second transfer portion 362 to the fifth slide section 335 by the action of the elastic restoring force of the elastic member 370, and allowing the shaft 320 to be slid to the third position-limiting portion 353 along the fifth slide section 335 and the sixth slide section 336. In the present process, the shaft 320 may be rotated. In the present way, the first end portion 321 of the shaft 320 may protrude from the inside of the housing 310 by the second predetermined length. Here, the degree to which the elastic member 370 is compressed may be reduced (here, the elastic member 370 may have a length longer than the shortest length when the elastic member 370 is compressed to the stable state), the length by which the first end portion 321 of the shaft 320 protrudes from the inside of the housing 310 may become shorter, the maximum rotation angle of the hinge arm 200 relative to the mounting bracket 100 may be greater, and the maximum angle at which the door may be opened may be greater.

Furthermore, when the passenger continuously applies the thrust P to the second end portion 322 of the shaft 320, the shaft 320 may overcome the elastic force of the elastic member 370, and the position-limiting pin 311 may be slid relatively from the third position-limiting portion 353 to the third transfer portion 363 along the seventh slide section 337. The passenger may then stop applying the thrust P, thus allowing the shaft 320 to be transferred from the third transfer portion 363 to the eighth slide section 338 by the action of the elastic restoring force of the elastic member 370, and allowing the shaft 320 to be slid to the fourth position-limiting portion 354 along the eighth slide section 338 and the ninth slide section 339. In the present process, the shaft 320 may be rotated. In the present way, the first end portion 321 of the shaft 320 may protrude from the inside of the housing 310 by the third predetermined length. Here, the degree to which the elastic member 370 is compressed may be further reduced, the length by which the first end portion 321 of the shaft 320 protrudes from the inside of the housing 310 may become even shorter, the maximum rotation angle of the hinge arm 200 relative to the mounting bracket 100 may be even greater, and the maximum angle at which the door is configured for being opened may be even greater.

Furthermore, when the passenger continuously applies the thrust P to the second end portion 322 of the shaft 320, the shaft 320 may overcome the elastic force of the elastic member 370, and the position-limiting pin 311 may be slid relatively from the fourth position-limiting portion 354 to the fourth transfer portion 364 along the tenth slide section 340. The passenger may then stop applying the thrust P, thus allowing the shaft 320 to be transferred from the fourth transfer portion 364 to the eleventh slide section 341 by the action of the elastic restoring force of the elastic member 370, and allowing the shaft 320 to be slid to the first position-limiting portion 351 (the initial length) along the eleventh slide section 341 and the twelfth slide section 342. In the present process, the shaft 320 may be rotated. In the present way, the first end portion 321 of the shaft 320 may protrude from the inside of the housing 310 by the fourth predetermined length (the initial length). Here, the elastic member 370 may be restored to the stable state of its longest length, the length by which the first end portion 321 of the shaft 320 protrudes from the inside of the housing 310 may be the shortest, the maximum rotation angle of the hinge arm 200 relative to the mounting bracket 100 may be the greatest, and the maximum angle at which the door is configured for being opened may be the greatest.

In the above process, the shaft 320 may be rotated by one turn, and the position-limiting pin 311 may thus be moved to the initial position within the position-limiting groove 330 of the shaft 320.

To better interpret and precisely define the scope of the appended claims, the terms “upper”, “lower”, “upper side”, “lower side”, “upper portion”, “lower portion”, “left”, “left side”, “right”, “right side”, “front”, “forward”, “back”, “backward”, “inner”, “outer” are intended to describe the features of the exemplary embodiments with reference to the locations of such features shown in the drawings.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An adjustable door hinge structure comprising:
a mounting bracket mounted on a vehicle body;
a hinge arm including a first end portion fixed to a door and a second end portion rotatably connected to the mounting bracket; and
a position-limiting assembly including a housing fixed to the mounting bracket and a shaft slidably protruding from an inside of the housing,
wherein the shaft is configured for being moved relative to the housing to change a predetermined length by which a first end portion of the shaft protrudes from an inside of the housing, thus changing a maximum rotation angle of the hinge arm relative to the mounting bracket.

2. The structure of claim 1,
wherein the position-limiting assembly further includes:
a position-limiting pin provided in the housing,
a position-limiting groove corresponding to the position-limiting pin provided at a middle portion of the shaft, and
an elastic member including a first end portion in contact with an end portion of the housing and a second end portion in contact with the shaft, and
wherein the elastic member allows the position-limiting pin to slide to a predetermined position within the position-limiting groove to change the predetermined length by which the first end portion of the shaft protrudes from the inside of the housing.

3. The structure of claim 2,
wherein a stop ring is disposed between the first end portion of the elastic member and the position-limiting groove and extends radially outwardly from a surface of the shaft, and
wherein the elastic member includes the second end portion in contact with the stop ring of the shaft.

4. The structure of claim 2,
wherein the position-limiting groove includes a plurality of slide sections,
wherein a loop is formed by sequentially connecting the plurality of slide sections, and
wherein a plurality of position-limiting portions are disposed between at a connection end portion between neighboring slide sections among the plurality of slide sections in the loop.

5. The structure of claim 4,
wherein the first end portion of the shaft protrudes from the inside of the housing by the predetermined length when the position-limiting pin is slid along the position-limiting portions, and
wherein the predetermined length is changed as the position-limiting pin is slid along the position-limiting portions.

6. The structure of claim 5,
wherein the plurality of slide sections include:
a first slide section, a second slide section, a third slide section, a fourth slide section, a fifth slide section, a sixth slide section, a seventh slide section, an eighth slide section, a ninth slide section, a tenth slide section, an eleventh slide section, and a twelfth slide section,
wherein the loop is formed by sequentially connecting the first slide section, the second slide section, the third slide section, the fourth slide section, the fifth slide section, the sixth slide section, the seventh slide section, the eighth slide section, the ninth slide section, the tenth slide section, the eleventh slide section, and the twelfth slide section to each other, and
wherein the plurality of position-limiting portions includes:
a first position-limiting portion disposed at a connection end portion between the twelfth slide section and the first slide section;
a second position-limiting portion disposed at a connection end portion between the third slide section and the fourth slide section;
a third position-limiting portion disposed at a connection end portion between the sixth slide section and the seventh slide section; and
a fourth position-limiting portion disposed at a connection end portion between the ninth slide section and the tenth slide section.

7. The structure of claim 6,
wherein the first end portion of the shaft protrudes from the inside of the housing by a first predetermined length when the position-limiting pin is slid from the first position-limiting portion to the second position-limiting portion sequentially along the first slide section, the second slide section, and the third slide section, while the shaft is simultaneously rotated,
wherein the first end portion of the shaft protrudes from the inside of the housing by a second predetermined length when the position-limiting pin is slid from the second position-limiting portion to the third position-limiting portion sequentially along the fourth slide section, the fifth slide section, and the sixth slide section, while the shaft is simultaneously rotated,
wherein the first end portion of the shaft protrudes from the inside of the housing by a third predetermined length when the position-limiting pin is slid from the third position-limiting portion to the fourth position-limiting portion sequentially along the seventh slide section, the eighth slide section, and the ninth slide section, while the shaft is simultaneously rotated, and
wherein the first end portion of the shaft protrudes from the inside of the housing by a fourth predetermined length when the position-limiting pin is slid from the fourth position-limiting portion to the first position-limiting portion sequentially along the tenth slide section, the eleventh slide section, and the twelfth slide section, while the shaft is simultaneously rotated.

8. The structure of claim 7, wherein the position-limiting groove is provided with a first transfer portion disposed at a connection end portion between the first slide section and the second slide section, a second transfer portion disposed at a connection end portion between the fourth slide section and the fifth slide section, a third transfer portion disposed at a connection end portion between the seventh slide section and the eighth slide section, and a fourth transfer portion disposed at a connection end portion between the tenth slide section and the eleventh slide section.

9. The structure of claim 1, wherein the mounting bracket includes:
a base plate fixedly mounted on the vehicle body,
first and second mounting plates each facing the base plate and including an axial hole, and
a connection plate connecting the first and second mounting plates to each other and including a connection hole.

10. The structure of claim 9, wherein the hinge arm includes:
a main body formed as an arc-shaped plate,
a fixing plate disposed at a first end portion of the main body and fixed to an internal plate of the door, and
a rotation shaft provided at a second end portion of the main body and passing through the axial hole.

11. The structure of claim 10, wherein at least a hook connection is disposed on the housing, and the housing is hooked to the connection plate by the at least a hook connection.

12. A vehicle including the adjustable door hinge structure of claim 1.
